(19) United States
(12) Patent Application Publication
(10) Pub. No.: US 2007/0246079 A1
(43) Pub. Date: Oct. 25, 2007

(54) Multi zone shower head for cleaning and drying wafer and method of cleaning and drying wafer

(76) Inventor: Xuyen Pham, Fremont, CA (US)

Correspondence Address: Tue Nguyen, 496 Olive Ave., Fremont, CA, 94539, US

(21) Appl. No.: 11/408,664

(22) Filed: Apr. 21, 2006

(51) Int. Cl. B08B 3/00; B08B 7/00

(52) U.S. Cl. 134/26; 134/33

(57) ABSTRACT

A method and system to clean and rinse and dry wafer comprises a precision control of an outward-moving inner boundary condition and a steady state edge boundary condition. The edge boundary condition can confine the liquid within the substrate by an edge liquid flow step, to create an outer liquid boundary, to confine the liquid within the wafer, and to compensate for liquid lost through process conditions such as wafer spinning. The outward-moving inner boundary condition can control or distribute the liquid within the substrate by an inner liquid boundary condition that moves outward to the edge of the wafer, to create an outward-moving inner liquid boundary, to uniformly distribute liquid within the wafer, and to uniformly drying the wafer.

This application is related to co-pending applications of the same inventor, entitled “Multi-zone shower head for drying single semiconductor substrate”, Ser. No. 11/032,852, filed Jan. 11, 2005, and “Systems and methods for spinning semiconductor wafers”, Ser. No. 11/038,509, filed Jan. 19, 2005, hereby incorporated by reference.

### FIELD OF THE INVENTION

This invention relates to systems and methods for processing substrates, and specifically for cleaning and drying of semiconductor wafers.

### BACKGROUND

In semiconductor fabrication, various layers of insulating, conducting and semi-conducting materials are deposited to produce a multilayer semiconductor device. Using various fabrication techniques such as coating, oxidation, implantation, deposition, epitaxial growth of silicon, lithography, etching, and planarization, the layers are patterned to form elements such as transistors, capacitors, and resistors. These elements are then interconnected to achieve a desired electrical function in an integrated circuit (IC) device.

In many operations, residual unwanted materials such as post-etch/post-strip chemicals and slurry particles accumulate on the surface of a wafer. If left on the surface of the wafer for subsequent fabrication operations, these unwanted residual materials and particles may cause, among other things, defects such as scratches on the wafer surface and inappropriate interactions between metallization features. In some cases, such defects may cause devices on the wafer to become inoperable.

To illustrate, fabrication operations such as plasma etching, stripping and chemical mechanical polishing (CMP) may leave unwanted residuals on the surface of the wafer. These unwanted residuals may be removed using water washing, chemical washing, sonic washing (for example Megasonic and ultrasonic), and brush cleaning with deionized (DI or DIW) water, or a separate post-CMP cleaning. The post-CMP step is typically achieved by mechanical brush cleaning, using a polyvinyl alcohol (PVA) brush or sponge and DI water, or potassium or ammonium hydroxide as the cleaning agent. Other surface preparation processes can include chemical processes using various liquid chemicals.

After the cleaning operation, a rinse is applied with DI water and a drying process is performed. One of the substrate drying processes conventionally known in the art is a spin dry process for rotating a substrate at high speeds to spin off water from the surface of the substrate by centrifugal force in a single-wafer type substrate processing apparatus for processing substrates one by one.

One purpose of drying the substrates is to remove water on the substrates after cleaning. Currently several drying methods have been used in electronic component industry. The methods include a spin-rinse dry method, a hot water slow pull method, a Marangoni-type process, and an isopropyl alcohol (IPA) process.

The spin-rinse dryer uses centrifugal forces to remove water from substrate surfaces. However, spin-rinse dryer is known to have problems such as water spotting, static electric charge build-up, and stress-induced substrate damage due to high speed spinning about 2500 RPM. In the hot water slow pull method, the substrates are immersed in a hot water bath, which is heated to 80-90° C., and then slowly pulled from the bath. When a substrate is pulled from the bath, a thin water film is formed on the surface of the substrate. Then, the thermal energy stored in the substrate evaporates the thin water film. For successful evaporation, the rate at which the substrate is separated from the bath must be matched to the evaporation rate. The hot water process has several shortcomings. When the substrate has a non-homogeneous surface, partly hydrophobic and partly hydrophilic, the substrate is likely to have watermarks or stains thereon. Further, condensation of water vapor on the substrate after the substrate is pulled from the hot water may produce watermarks or stains on the substrate.

Since spin dryers or IPA vapor dryers cannot completely remove watermarks that occur on a wafer surface or between patterns, Marangoni dryers have been developed. The Marangoni dryer uses a difference between surface tenses of the IPA and water. The Marangoni-type process involves the introduction of a polar organic compound which dissolves in the liquid and thereby reduces the surface tension of the liquid. U.S. Pat. No. 6,027,574, entitled “Method of drying a substrate by lowering a fluid surface level”, shows a Marangoni-type process. According to the Marangoni principle, fluid flows from low surface tension region to high surface tension region. In the Marangoni-type process, while the substrate is separated from the bath containing water that is at room temperature, the water is driven away from the substrate because of the Marangoni effect. To avoid condensation of water vapor on the surface of the substrate, the Marangoni-type process does not use hot water. After wafers are rinsed out by de-ionized water, the IPA vapor is fed to an upper interior space of a rinsing bath and the DI water is slowly withdrawn. Thus, the water is eliminated from a wafer surface. When the DI water is completely drained, the nitrogen of high temperature is fed into to evaporate the DI water remaining on the wafer surface. If the evaporated DI water and residues including particles are not fully issued out, they can cause the irregular liquid flow (turbulence) in the rinsing bath together with the nitrogen, so that the wafer surface is not uniformly dried and the water remains at a portion contacting with a wafer guide. In addition, since the Marangoni dryer cannot fundamentally prevent oxygen from reacting on the wafer, it cannot suppress formation of an oxide layer.

As noted in U.S. Pat. No. 6,625,901, several issues arise with conventional Marangoni-type process. First, the drying speed of the process is low, because the substrate is dried at room temperature, and the chamber is purged of the remaining IPA vapor for an extended period of time (3-5 minutes) after being removed from the water. Accordingly, drying cost is high. Second, although room temperature water is used, there is still a condensation problem during and after the separation of the substrate from the water. Water vapor condenses on the substrate and forms micro droplets that leave a residue behind, causing defects in subsequent manufacturing processes. Fourth, purging of IPA while the substrate is dried in the chamber may cause condensation of water vapor.

### SUMMARY OF THE INVENTION

Disclosed are the methods and apparatuses for clean and drying of semiconductor wafers or LCD flat panel display and can be used as post-CMP clean, Dry/wet Post-Etch Residue cleans (Polymer Removal), Photoresist Removal and surface preparation (FEOL & BEOL), Pre-Photo Lithography, Pre-Deposition clean and dry, Back Side Metals Clean, Back Side Films Etch (Front side and/or backside), Pre-Epi Clean etc.

The present invention discloses a system and method to establishing, maintaining and propagating liquid boundary conditions within the substrate. The edge boundary condition can confine the liquid within the substrate by an edge liquid flow step, to create an outer liquid boundary, to confine the liquid within the wafer, and to compensate for liquid lost through process conditions such as wafer spinning. The outward-moving inner boundary condition can control or distribute the liquid within the substrate by an inner liquid boundary condition that moves outward to the edge of the wafer, to create an outward-moving inner liquid boundary, to uniformly distribute liquid within the wafer, and to uniformly drying the wafer.

For cleaning operation, the moving inner boundary condition is established by providing a cleaning liquid agent flow at the center zone, and then radially moving the flow outward. For rising and drying operation, the moving inner boundary condition is established by providing a rinsing or drying mixture flow at the center zone, and then radially moving the flow outward. Marangoni's principle can be used where fluid flows from a low surface tension region to a high surface tension region to effectively drying the wafer surface.

The system thus comprises a shower head with multi-air zones using controlled cleaning agent or drying agent and wafer rotation to clean and dry wafer surface. The combination of N₂/IPA flow and pressure, spinning speed, DIW boundary control at the wafer edge and centrifugal force of the spinning wafer pushes the water to move toward the edge of wafer. Following the DIW rinse to remove any chemical residues on wafer from previous cleaning processes, the system can dry the wafer surface by providing pressure or flow from center zone to outer zones, creating a disruptive DIW meniscus, with the IPA assisting the drying process by the Marangoni effect.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 illustrates an exemplary multi-zone shower-head system with controlled zones.

FIG. 2 illustrates an embodiment of the present invention with front and back option.

FIG. 3 illustrates another embodiment of the present invention with front and back option.

FIG. 4 illustrates exemplary process steps for drying wafers.

FIG. 5 illustrates an edge drying nozzle position.

FIG. 6 illustrates a clean and drying system diagram.

FIG. 7 illustrates a recipe with process matrix parameters.

FIG. 8 illustrates various process applications.

### DETAILED DESCRIPTION OF THE INVENTION

The present invention discloses a system and method for wet process a substrate such as a semiconductor wafer or a LCD flat panel display. The disclosed invention is well suitable for cleaning and rinse and dry operation, and therefore the invention is described with reference to these embodiments. Other wet processes such as etching, depositing, coating, spin coating, and soaking can be applied with change in chemicals and routine optimization.

To achieve a reliable and repeatable wet process, the liquid contacting the substrate must be well controlled. Thus the present invention discloses a system and method to establishing, maintaining and propagating liquid boundary conditions within the substrate.

Specifically, in one aspect of the invention, the present invention provides an edge boundary condition to confine the liquid within the substrate. Normally, during wet processing of single wafer system, the liquid will be pushed off the edge, for example, by providing liquid at the center of the wafer, or by spinning the wafer. The variation of the liquid draining to the wafer edge can be significant, leading to variation in processing parameters and thus defects and yield lost. The present invention discloses an edge liquid flow step, to create an outer liquid boundary, to confine the liquid within the wafer, and to compensate for liquid lost through process conditions such as wafer spinning.

With an edge liquid flow, the liquid is uniform confined within the wafer even in the presence of a centrifugal force resulting from the spinning of the wafer. In fact, the wafer spinning also provides a uniform distribution of the edge flow with only one or two edge nozzles. The flow of the edge nozzles will be dependent on the rotation speed of the wafer, as well as the hydrophobicity or hydrophillicity of the wafer surface. The edge flow can enable the soaking, as well as etching or cleaning, of the wafer since the liquid is uniformly distributed across the wafer. The process also enables a low rotation speed, as well as low liquid dispensing.

In another aspect of the invention, the present invention provides an outward-moving inner boundary condition to control or distribute the liquid within the substrate. Normally, during wet processing of single wafer system, the liquid will be dispensed from fixed locations, and distributed throughout the wafer by the centrifugal force resulting from high-speed spinning the wafer. The variation of the liquid distribution can be significant, leading to variation in processing parameters and thus defects and yield lost. Further, the wafer rotation speed can be high, ranging from hundred of rmp (rotation per minute) for liquid distribution to thousand of rpm for wafer drying. The present invention discloses an inner liquid boundary condition that moves outward to the edge of the wafer, to create an outward-moving inner liquid boundary, to uniformly distribute liquid within the wafer, and to uniformly drying the wafer.

For cleaning (and other wet processes) operation, the moving inner boundary condition is established by providing a cleaning (or other process chemical) liquid (or liquid/gas or vapor/gas mixture) agent flow at the center zone, and then radially moving the flow outward. With the edge flow maintaining a liquid (such as solvent or water) thickness on the wafer, the outward-moving flow of cleaning agent can uniformly stir the liquid thickness, uniformly dispense the cleaning agent, and thus enabling the uniformly cleaning the wafer. Multiple passes can be employed for deep cleaning, or for different chemistry. A water clean last pass can be used to remove all cleaning agent from the wafer surface.

For rising and drying operation, the moving inner boundary condition is established by providing a rinsing (liquid/gas mixture or vapor/gas mixture) or drying gas (or vapor/gas mixture) flow at the center zone, and then radially moving the flow outward. With the edge flow maintaining a liquid (such as solvent or water) thickness on the wafer, the outward-moving flow of rinse/dry gas can uniformly pushing the liquid outward, effectively establish a outward-moving front where the wafer is dried in the inner side and retained a liquid thickness at the outer side. This drying operation eliminates water streak marks since the inner side always dries before the outer side. This drying operation further enables a low rotation drying process, since the drying operation is accomplished by the outward-moving dry/liquid boundary, and not due to centrifugal force. The rotation condition is typically needed only to provide a uniform edge flow from a minimum number of edge nozzles. With proper design of uniform edge flow, or with a design to provide a rotation of edge flow, the drying process can be accomplished without any spinning. Multiple rinsing/drying passes can be employed for deep cleaning, or for different chemistry.

In another aspect of the invention, the present invention provides a single wafer drying process employing Marangoni's principle where fluid flows from a low surface tension region to a high surface tension region. By maintaining an outer high surface tension region with a liquid edge flow (for example using water), and by introducing an inner low surface tension region with an outward-moving inner flow (for example with IPA/inert gas mixture), the water can move completely outward to achieve a drying wafer surface, even with low or zero rotation wafer rotation. The process can control the surface tension of the water meniscus over the entire wafer surface with carefully optimized process conditions. The process can employ an azeotrope, for example IPA/DIW azeotrope, for the complete vaporization of remaining water on the wafer surface. An azeotrope is a mixture of liquids at a specific composition, thus has a constant boiling point because the vapor has the same composition as the liquid mixture. An IPA/DIW azeotrope will have a constant boiling temperature that is lower than that of DIW, and that the composition of the IPA/DIW does not change by partial evaporation. The azeotrope mixture can be DIW with IPA (isopropyl alcohol), ethyl glycol, diacetone, or methylpyrrolidone. In another embodiment, the present invention discloses a method for drying wafer with low rotation speed, through the outward-moving inner flow, the edge flow, the Marangoni principle, or any combination thereof.

In a preferred embodiment, the combining force of each circular N₂/IPA vapor air zones, the spinning speed, DIW (de-ionized water) boundary control from flow at the wafer edge and the centrifugal force of the spinning wafer urges the DIW or other aqueous-based chemical to move toward the edge of wafer. A DIW clean or rinse can be first used to remove any chemical residues on wafer from previous cleaning processes, then DIW or other aqueous-based chemical is flooded on the wafer surface for surface wetting with controlled wafer rotation RPM, then drying agent or an aqueous vapor is coating to the surface of wafer, starting from center zone to outer zones. The drying agent creates a disruptive on the surface of the wafer of the DIW meniscus with the IPA assists in drying the wafer by the Marangoni effect. The resulting surface tension gradient pushes water away from wafer center as it is rotated and liquid DIW continuously flow to the edge of wafer at controlled flow rate. The process controls the surface tension and boundary condition of the water meniscus over the entire wafer surface with the change in rotation speed, by starting with a low rotation rpm and gradually increasing the rotation speed to completely remove rinse liquid from the wafer edge. The controlled displacement of DIW with heated optional N2 or carrier gas can evaporate residual thin film on the entire wafer to prevent water mark on wafer. This process lower the cost for each wafer by eliminating the need for post-clean and batch IPA dry on porous and hydrophobic film of copper/low-k interconnects wafer.

The system according to the present invention comprises a multi-zone shower head with multi-air zones controlled by a manifold for cleaning agent or drying agent and a wafer rotation assembly to clean and dry front wafer and a rotation arm with attached nozzles to clean and dry backside of wafer. The multi-zone shower head covers the entire wafer surface, with each circular air zone in the shower head can flow N₂/IPA, an aqueous vapor or heated N₂, adjustable with the wafer rotation speeds. The system can comprise separate wafer edge flow assembly for providing flows at the wafer edge. In a preferred embodiment, the multi-zone shower head can provide wafer edge flow at the outermost zones for confining the liquid within the wafer. The multi-zone shower head can include a plate having zones of plurality nozzles, with each of the nozzle zone assigned to one or more of a plurality of processing zones for the wafer. The nozzle zones are controlled in each processing zone by a manifold assembly coupled to the pressure regulator or MFC. Each processing zone can provide an aqueous vapor flow, a gas, a gas mixture or a compressed liquid. A plurality of control devices can be used with the manifolds to control volume, flow rate, and pressure of each processing zone. The processing zones can include a plurality of nitrogen and IPA vapor zones. A rotating platform can be used to rotate the wafer. The platform can generate a centrifugal force during wafer spinning to urge an aqueous solution to move toward a wafer edge. The aqueous solution can be DIW and can be rinsed to remove any chemical residues on the wafer. The processing zones can flow N2/IPA mixture or heated nitrogen during wafer rotation to evaporate residual thin film on the wafer and to prevent water marks on the wafer. The shower head assembly plate can be concentric or non-concentric with the wafer or the assembly plate can be concentric or non-concentric with the platform to rotate the wafer. Additional nozzle head(s) can access second (back side) sides of the wafer for additional processing. The system can comprise an integrated turntable for holding and rotating a substrate.

The present invention can be applied to process first and second sides of a substrate (such as the front and back of the wafer or a flat panel display, for example) by providing a first and second heads to access both of the substrate. The first head can be a shower head as disclosed above. The shower head with multiple nozzle zones can be positioned above the first side (front side) to process this side, and second nozzle heads to process the second side (back side) of the wafer. The head/arm assembly can provide a linear motion or a radial arm motion. Also, a variety of heads/arms can be used for a variety of applications. In cleaning and drying applications, the system efficiently cleans and dries the wafer after fabrication operations that leave unwanted residue on one or both surfaces of the wafer.

The system further can include a drive assembly to actuate the platform, a first bowl to collect material from the first head, a second bowl to collect material from the second head, and a moveable shroud to load and unload the wafer and to contain material from one or more of the heads. The nozzles can discharge air, gas, or a mixture thereof. The nozzles can also discharge a liquid material, a chemical material or a gaseous material. The wafer can be positioned offset from the shower head.

An outer processing zone can be used to dry a wafer edge (with less than 20 nozzles in one embodiment). The outer edge zone of the shower head can be used to dry wafer edge.

The shower head is typically located at the top of the substrate spinning apparatus, and can move up/down at the appropriate position by air cylinder or motor. The shower head can move vertically above the wafer, and alternatively can be rotated and pivoted up and down, and can be rotated side way as well as moved up and down. The shower can be located concentric or not to the wafer spinning apparatus. Its also can located concentric to wafer spinning apparatus but still have the wafer offset from the spinning apparatus.

The shower head with multi-air zones control an aqueous vapor flow, gases, gas mixture and wafer spinning apparatus to perform front wafer processes. Various combination of gas, gas mixture or liquid can be flowed through the shower head zones. The systems of manifold and control device enable a precise control of volume, flow rate, and pressure of each zone. The shower head with multi-air zones controlled nitrogen/IPA or an aqueous vapor flow and wafer rotation apparatuses to dry front wafer and rotation arm with attached air nozzle(s) to dry the backside of the wafer. Combining the force from each circular nitrogen/IPA vapor air zones and the centrifugal force of the spinning wafer urges DIW or other aqueous based to move toward the edge of wafer.

In an exemplary Shower Head Vapor Dry (SHVD) process, DIW is rinsed to remove any chemical residues on wafer from previous cleaning processes. As required for surface treatments, nitrogen/IPA or an aqueous vapor can be used to coat the surface of wafer as (heated) DIW or other aqueous-based solutions floods the wafer surface for wetting the wafer surface. A controlled wafer rotation is performed and the multi-zone shower head applies N2/IPA vapors, starting from a center processing zone and moving to outer zones. The N2/IPA assists in drying the wafer using the Marangoni effect. The resulting surface tension gradient pushes water away from wafer center as it is rotated. Each circular air zone in shower head can continue to flow N2/IPA mixture or heated nitrogen at one or more wafer rotation speed(s) to evaporate residual thin films of liquid solutions on the wafer to prevent the formation of water marks on the wafer. This process save time, lower the cost for each wafer by eliminating the need for post-clean and batch IPA dry on porous and hydrophobic film of copper/low-k interconnects wafer without leaving water marks.

The present invention is particularly suited for clean and rinsing and drying of semiconductor wafers and can be used as post-CMP clean, Dry/wet Post-Etch Residue cleans (Polymer Removal), Photoresist Removal and surface preparation (FEOL & BEOL), Pre-Photo Lithography, Pre-Deposition clean and dry, Back Side Metals Clean, Back Side Films Etch (Front side and/or backside), Pre-Epi Clean, etc. With a drying module, integrated system do not required wet wafer transfer from module to module, thus improving throughput and reducing wafer stress, contamination and defects.

Water marks and wafer stress on the wafer are virtually eliminated using the multi-zone shower head and using centrifugal forces exerting during the slow spinning to dry wafer (5 to 600 RPM). The system efficiently dries the wafer after fabrication operations that leave unwanted residue on one or both surfaces of the wafer. The improved wafer cleaning/drying minimizes the undue costs of discarding wafers having inoperable devices.

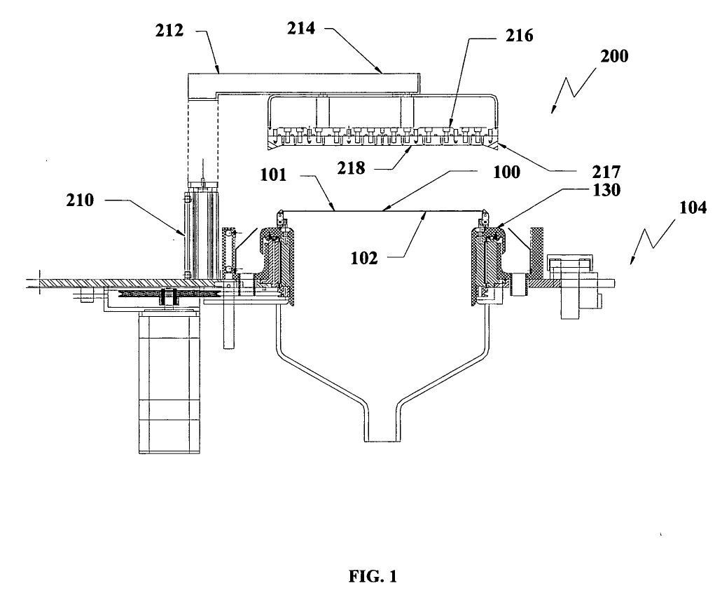

FIG. 1 illustrates an exemplary multi-zone shower-head system for processing wafers. The multi-zone shower head assembly 200 is moveably positioned above a wafer 100 using an actuator 210 that is connected to the head assembly 200 through an arm 212. The shower head assembly 200 includes a cover 214 that houses a plurality of air lines and fittings to each process zone, a top plate 216 and a bottom plate 218. The shower head 200 further comprises an edge nozzle 217 located at the edge of the shower head. The wafer 100 has first and second sides 101 and 102 (in this case the front and back wafer sides) and is mounted on a platform 104, comprising a spinning module 130 and adapted to securely receive and rotate the wafer.

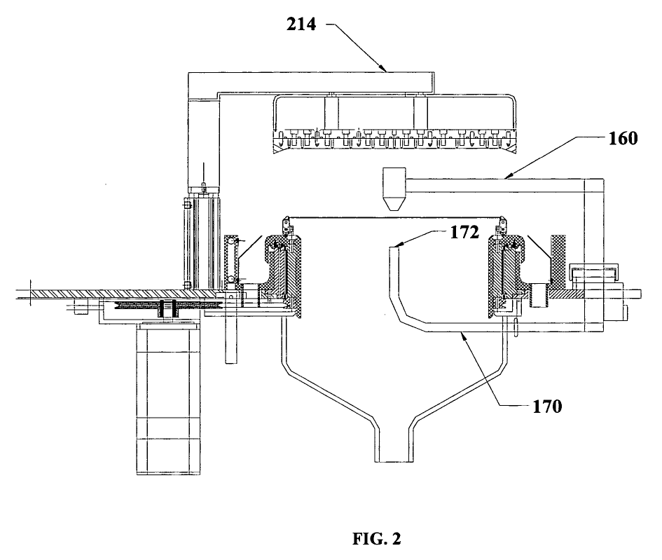

The system can be configured to process both sides of the wafer. FIG. 2 shows an embodiment where the shower head assembly 200 can move to an upper position to enable both sides of the wafer 100 to be accessible by instruments such as process heads 160 and back side wafer drying nozzle 172. As shown, the apparatus 200 has a hollow center to allow first and second process heads 160 and arm 170 mounted on the platform 104 to access the first and second sides 101 and 102 of the wafer 100. The first head 160 is positioned above the top side of the wafer 100 and the second head 172 is positioned below the bottom side of the wafer 100. A wafer substrate holder is located on top of an inner housing to hold the substrate or wafer 100 in proper position while the wafer 100 is rotating. The platform 104 is designed to allow nozzles and process heads to reach wafer from both sides without restriction.

The heads 160 and 172 include nozzles at one end of each of heads for ejecting/spraying streams of processing materials onto the surfaces of the wafer 100. The head can be a sonic device such as a Megasonic nozzle, high pressure nozzle, brush and among others. The heads 160 and 172 can be mounted on a radial arm as shown or alternatively can be actuated by a linear motor. The heads 160 and 172 can move radially over the wafer 100, together or independently. More than one head/arm can be used with the platform as required. Each head 160 or 172 includes one or more nozzles, expelling air, gas, or a mixture thereof. Alternatively, at least one of the nozzles expels a liquid material such as DI water or a chemical material/substance. The nozzles can also emit materials at an ultrasonic or Megasonic energy or frequency. The head 160 can be a wafer cleaning device such as PVA brush with close loop control for speed and down force.

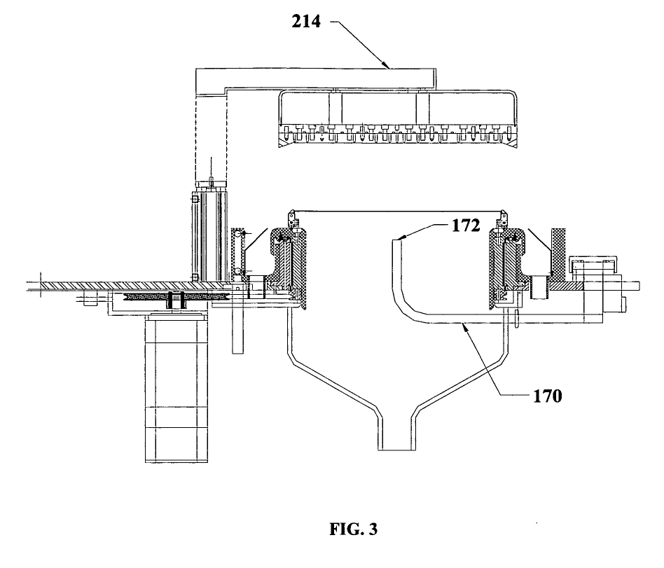

FIG. 3 shows an alternative configuration where the shower head assembly 200 is positioned to process the front side of the wafer 100, with the backside of the wafer is processed by the backside nozzle 172. The shower head assembly 200 can have up/down or sideway movement to allow the loading or unloading of the wafers.

The wafer can be a semiconductor wafer of all sizes, and preferably wafers with large size of 200 mm or larger, and more preferably for wafers in the range of 200 mm to 450 mm. The wafer can also be any thin flat substrate such as a flat panel display substrate. The wafer can be positioned centerly of can be positioned at an offset from a spindle center.

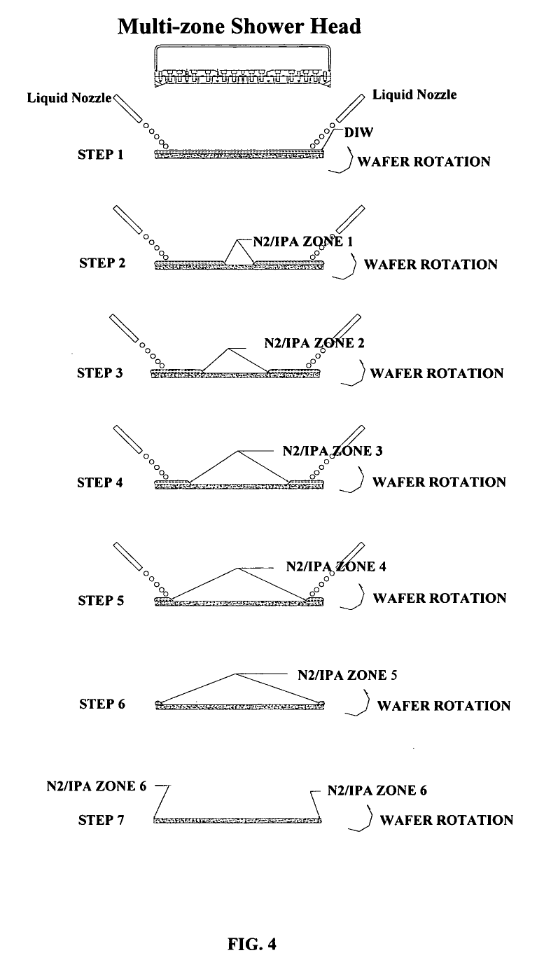

FIG. 4 illustrates an exemplary drying process using a multi-zone shower head together with edge flow liquid nozzle. When the wafer is spun, centrifugal force pushes the DIW in outward-moving zones from the wafer center toward the edge of the wafer. In drying a substrate, the drying apparatus increases the wet ability of the substrates or wafers and promotes the separation of water or fluid from the substrate and dries the substrate by transferring of thermal energy to the substrate. Since the N₂/IPA vapor supplied to the interface between the substrate and the fluid has lower surface tension than the fluid does, the N₂/IPA vapor dissolved on the top surface of the fluid in the bath promotes the removal of the fluid from the substrate while the substrate is pulled from the fluid in the bath. That is, the surface tension difference between the bulk fluid and the N₂/IPA/fluid mixture promotes the separation of the fluid from the substrate. Further, the N₂/IPA vapor increases the wet ability of the substrates.

The process starts with a wafer handler pulls a wafer from a storage, such as a wafer cassette or a FOUP, and placed on the cleaning and drying apparatus of the present invention. While wafer is in drying processes, N₂/IPA vapor can be provided to the interface between wafers and DI water, and heated N₂ can be used to provide additional drying of the wafer. As is typical, nitrogen is passed through a bubbler (not shown) that contains liquid IPA and is connected to an inlet manifold. A SMR (Self-Metering Reservoir) bubbler can be used to generate the mixture. N₂/IPA mixture also can be generated from atomizer nozzle chamber.

The wafer starts spinning slowly, and a layer of DIW is flooded on the surface of the wafer. The liquid nozzle edge flow is also turned on to ensure of the containing the liquid within the wafer. Next, pressure regulator or MFC of the innermost zone 1 of the manifold is actuated to turn the nozzle corresponding to N₂/IPA zone 1. The nitrogen and IPA vapor is provided to the interfaces between the wafer and DIW to increase the wet ability of the surface of the wafer and to promote the removal of water and dry the wafer.

Next, pressure regulator or MFC of the next zones (zone 2 through zone 4) of the manifold is actuated to turn the nozzle corresponding to N₂/IPA zone, together with the liquid nozzle edge flow. Finally, for the last few zones at the very edge, the liquid nozzle edge flow is turned off while the pressure regulator or MFC of these zones is actuated to complete the drying cycle. Thus, the spinning of the wafer combined with selective activation of nozzles enable the DIW to be removed without staining the wafer with watermark, among others. The inner zone(s) can continuously flow the N2/IPA mixture or heated N2 while the outer zone(s) can perform dry processing.

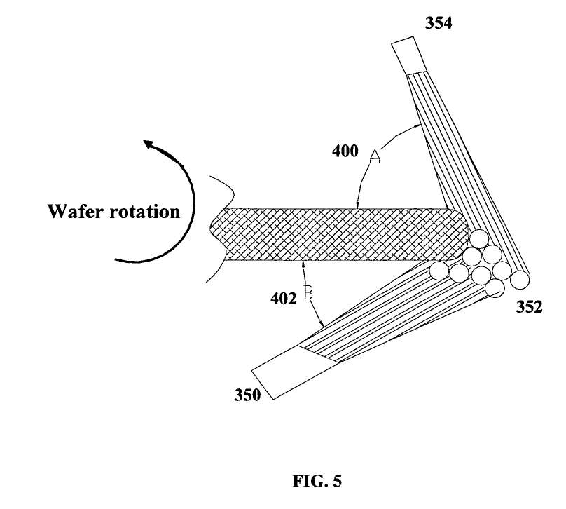

FIG. 5 shows an innovated wafer edge drying process. The system comprises a front side drying nozzle 354 delivering a drying agent to the front wafer edge, forming a front side incident angle 400. The system further comprises a backside drying nozzle 350 delivering a drying agent to the back wafer edge, forming a backside incident angle 402. With higher pressure or flow from the front side nozzle 354 compared to the backside nozzle 350, and with higher front side incident angle 400 compared to backside incident angle 402, the DIW 352 at the wafer edge will be pushed downward and away from the wafer edge, resulting in a complete edge drying process. This process can be accomplished with all wafer rotation speed, but preferable with low rotation speed for ease of equipment handling. Conventional high speed spinning for drying process can push all the water on both surfaces, front and back, but there is little pushing force at the wafer edge, and thus even at very high rotation speed, the wafer edge might not be completely dry. The present invention edge drying nozzle position and pressure or flow can accomplish a complete wafer edge drying process.

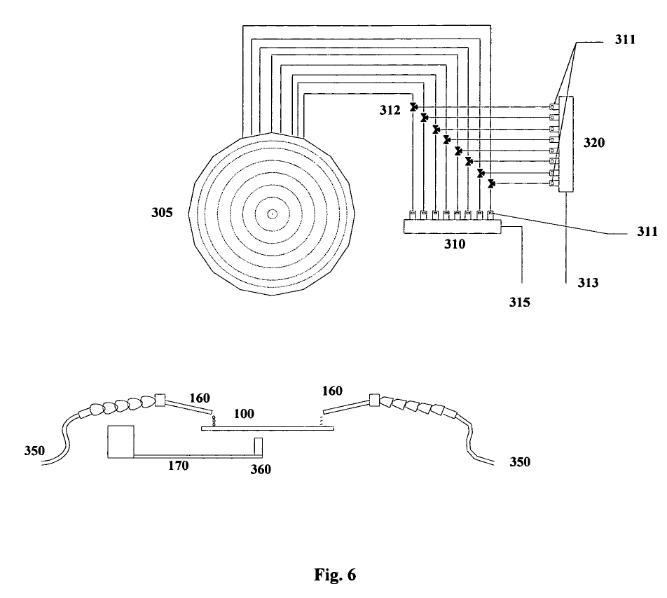

FIG. 6 shows a diagram for the cleaning and drying system. A first manifold 310 distributes an input gas 315 such as heated nitrogen to a manifold and control pressure regulators or MFC 311. Correspondingly, a second manifold 320 distributes an input vapor 313 such as N2/IPA mixture, or suitable vapor/mist to a manifold and control pressure regulator or MFC 311. The supply lines 313 and 315 are provided to an array of three-way valves 312. The valves 312 are controlled by a controller or computer and are selectively turned on to provide the gas to selected zones on the shower head 305 to the wafer at selected times as needed. DIW or cleaning/drying chemical can be provided to predetermined zones on top or edge of the wafer 100 through nozzles 350, delivering to the top wafer edge 160, while cleaning/drying chemical can be provided to predetermined zones on the bottom of the wafer 100 through nozzles 360 by the arm 170.

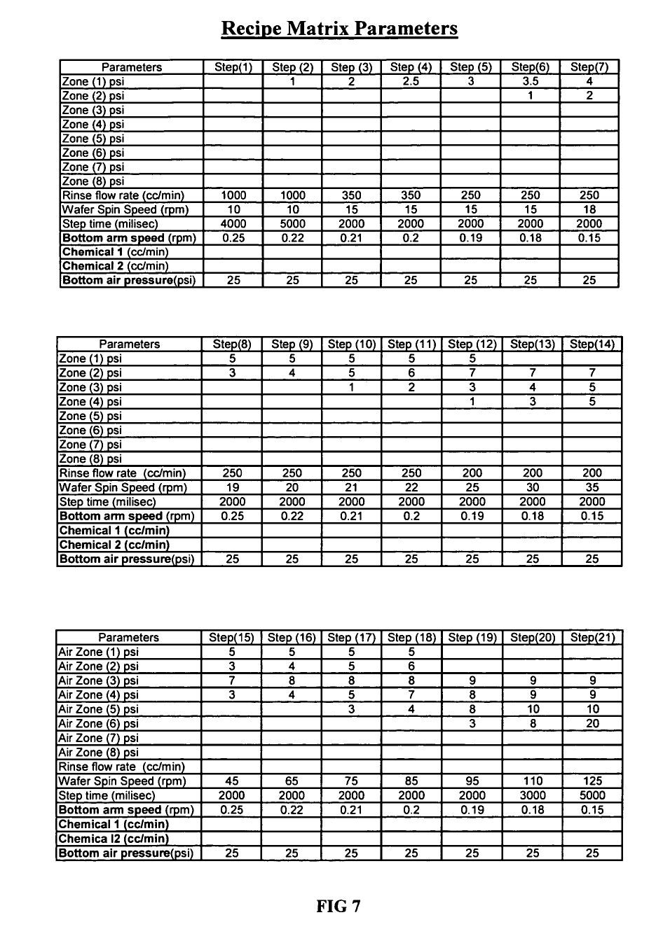

FIG. 7 shows a recipe for a drying process employing matrix parameters. The parameters include the pressure for the various zones of the shower head, the rinse flow rate, the speed of the wafer spinning, the time for various steps, the speed for the bottom arm and pressure, and the different chemicals delivered to the shower head or the bottom nozzle. The exemplary recipe comprises 21 steps, for a few seconds duration in each step. The recipe starts with a flooding the wafer with the rinse liquid, then the pressures in the zones gradually increase to create an outward-moving front to push the liquid out of the wafer. In the same time, the wafer also gradually picks up speed, rotating from a speed of 10 rpm at the start flooding step to a speed of 150 rpm at the end spinning dry step. The wafer can be successfully dry at a maximum drying speed of 150 rpm.

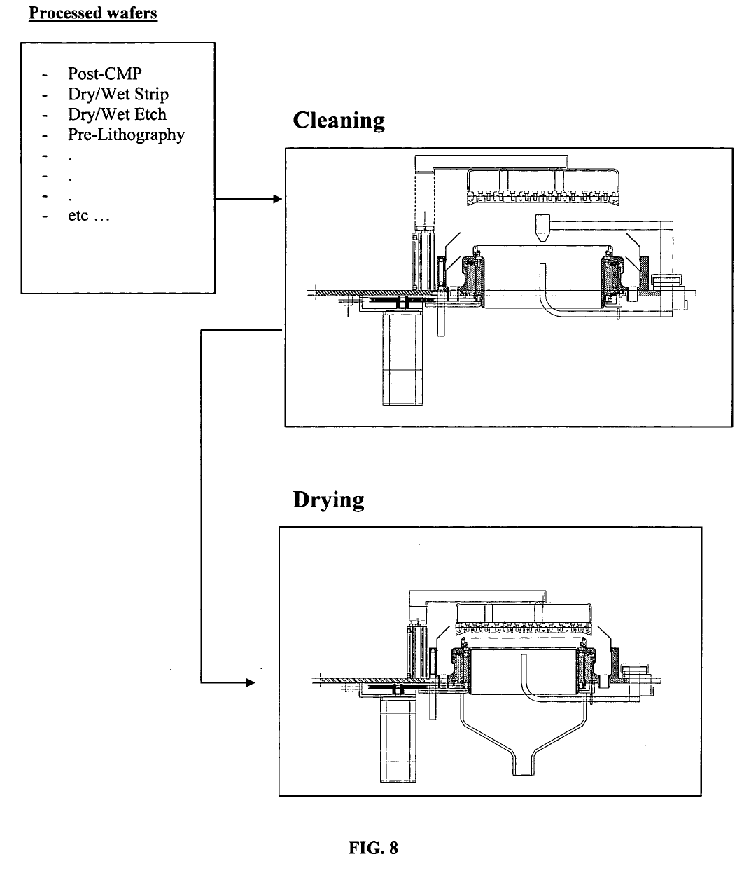

FIG. 8 shows an embodiment of an integrated application using two sequential processes of cleaning and drying. The cleaning application can use two nozzles for the front and back cleaning. The drying application can use a shower head for front side drying and a nozzle for backside drying. In an embodiment of the invention, the clean process and the dry process can be performed in a single module.

The present invention discloses a system and method for cleaning wafer through an edge flow, or an outward-moving inner flow. The edge flow alone can provide a soak, etch or clean of a wafer through the controlling of liquid outer boundary condition. The outward-moving inner flow alone can also provide a soak, etch or clean of a wafer through the controlling of a moving liquid boundary condition. The outward-moving action can be repeated for multiple pass processes. Both edge flow and outward-moving inner flow can be combined for optimum processing performance.

The cleaning process can further comprise a spinning module having wafer clamp chuck to hold wafer during rotation. The cleaning process can perform through a nozzle or through a multi-zone shower head. The multi-zone shower head can be movable and can move to the top of the wafer for cleaning process. The distance between the bottom of shower head and the top surface of the wafer can be optimized for process performance, and preferably between from 2 to 8 inches, and more preferably about 3 inches. The cleaning process can comprise a backside nozzle for cleaning wafer simultaneously. The cleaning system can comprise a shroud covering the wafer, in which the shroud moves up during process steps to avoid water splashing to outside and moving down during loading and un-loading wafer for accessing to the rotation platform. The cleaning process is preferably controlled by a computer in which the process flows from zone to zone is controlled by recipe matrix parameters. The cleaning process can starts with the cleaning agent flows from center zone then moves gradually to the edge zone. The cleaning process can provides uniform flow with the showerhead uniformly dispense chemicals on the wafer. The cleaning process can be repeated by allowing different type of cleaning agent can be dispended on same zone for additional cleaning after each zone complete. The cleaning process can be performed from both sides in which the back side of wafer can be cleaned from nozzle with same or different cleaning agent from the front side. The backside nozzles can be rotated from wafer center to edge or moved linearly from center to edge. The cleaning process can be performed where the cleaning agent flow and travel speed of the nozzles backside can be controlled to match wafer spinning. The cleaning agent could be a RCA-based chemical, HF, H₂SO₄, HNO₃, HCl, H₂O₂, H₂CO₃, or any combination thereof. The cleaning agent could also be a liquid, a saturated vapor, vapor phase, or a mixture with inert gas.

The following is an embodiment of a wet process according to the present invention. This process maintains a uniform layer of liquid on the wafer surface. This process can be applied for soaking the wafer surface, etching the wafer surface, or cleaning the wafer surface.

1. Preparing the process. This step includes the step of lowering a shroud to allow access to wafer clamp chuck, loading a wafer to the wafer clamp chuck, lowering the chemical dispenser such as the shower head or the liquid head to proper position relative to wafer surface, raising the shroud to prevent splashing, and entering a recipe matrix to input to the computer all parameters for controlling process for each step.

2. Providing a layer of liquid on the top surface of the wafer. The liquid can be water, DIW, a cleaning agent, or any chemical agent for processing the top surface. This step can be optional.

3. Spinning the wafer to spread out the liquid on the wafer surface. The spinning is preferably gradual, starting slowly and the increasing speed gradually. This step is also optional.

4. Flowing another liquid onto the vicinity of the edge of the wafer to maintain the liquid layer on the top substrate surface. The wafer spinning will push the liquid out of the wafer, thus the edge flow is needed to establish a boundary condition, or to generating a steady state layer of liquid on the wafer surface. With the wafer spinning, only one or two edge nozzles are adequate for supplying the edge flow to all the circumference of the wafer. If the wafer is not rotated, then more nozzles might be needed for uniformly distributed the edge flow. Also rotating edge flow might help in the uniform distribution. The edge liquid is preferably the same liquid as the liquid layer on the wafer, but it could be different.

The edge flow is designed to generate a steady state layer of liquid on the wafer surface, thus an optimization of many parameters is needed, such as the edge flow, the rotation of the wafer, the liquid properties such as viscosity, the wafer surface properties such as hydrophobicity, hydrophillicity.

The following is another embodiment of a wet process according to the present invention. This process dispenses a uniform layer of liquid on the wafer surface. The following description is for a cleaning process, but it could be adapted soaking the wafer surface, etching the wafer surface, or other wet processes.

1. Preparing the process.

2. Rotating the wafer. The spinning is preferably gradual, starting slowly and the increasing speed gradually. This step is optional, and preferably employed for uniform processing.

3. Dispensing a flow of a cleaning agent from the center zone or from a vicinity of the center zone onto the front side of the wafer. The wafer is preferably spinning at controlled speed and duration during the dispensing step for uniform distribution. Further, the centrifugal force resulting from the rotation pushes and urges the liquid agent moving and flowing out to the edge of wafer. The rotation is preferably running from slow to fast, and controlled by the recipe matrix parameter. The cleaning agent can be a liquid, a saturated vapor, a vapor, or any combination thereof. The cleaning agent can be water, DIW, a RCA-based chemical, HF, H₂SO₄, HNO₃, HCl, H₂O₂, or H₂CO₃.

The cleaning flow is preferably dispensed circumferentially in a ring pattern. The cleaning flow can also be dispensed linearly in a line pattern. The cleaning flow and pressure is preferably controlled to match the rotation speed of the wafer.

4. Propagating the flow of the cleaning agent outward toward the edge of the substrate. The propagating process can comprise the dispensing subsequent flows of the cleaning agent closer to the edge of the substrate than the previous flows. The propagating process is preferably performed by the continuing dispensing a flow of cleaning agent at subsequent outer zones. During the subsequent flows, the previous flows can be stopped or can still be flowing. The flow rate or the pressure of the previous flows is preferably higher than those of the subsequent flow to move the cleaning agent toward the edge of the substrate. The flowing rate or the pressure of the flows is preferably gradually increased with time for better process control. The propagation starts at the center zone, then moves to outer zones, and finally stops at the edge zone to clean the entire wafer. The propagating flow is preferably dispensed circumferentially in a ring pattern, or can also be dispensed linearly in a line pattern. The flow propagation speed is preferably controlled to match the substrate rotational speed.

The cleaning process can also comprise a step of uniformly dispensing liquid agent on the wafer. After each zone is clean, depending on the process requirements, different type of cleaning agent can also be dispended for additional cleaning step. Thus the flow propagation from the center to the edge of the substrate is repeated with the same liquid agent or with different liquid agent.

5. The backside of wafer can also be cleaned from nozzle with the same or different cleaning agent in the same time. The backside nozzles can be rotated from wafer center to edge or moved linearly from center to edge. The cleaning agent flow and the travel speed of the nozzles backside can be controlled to match wafer spinning.

The present invention can be applied toward a rinsing and drying process. The rinsing and drying process can further comprise a spinning module having wafer clamp chuck to hold wafer during rotation. The substrate can be a wafer, preferably 200 mm to 450 mm size. The rinsing and drying process can perform through a nozzle or through a multi-zone shower head. The multi-zone shower head can be movable and can move to the top of the wafer for rinsing and drying process. The shower head can starts the rinsing process at an upper position, where the distance between the bottom of shower head and the top surface of the wafer can be optimized for process performance, and preferably between from 2 to 9 inches, and more preferably about 4 inches.

The process can comprise a backside nozzle for rinsing and drying wafer simultaneously. The process is preferably controlled by a computer in which the process flows from zone to zone and the multi-step control of process parameters are controlled by recipe matrix parameters. The process can starts with the cleaning agent flows from center zone then moves gradually to the edge zone. The process can use the Marangoni effect where the surface tension reduction agent is IPA vapor in inert carrier gas. The process can use a rotation speed from 5 rpm to 450 rpm for the entire process, depending on the surface condition of the wafer film surface (hydrophilic, hydrophobic or combination of both hydrophilic/hydrophobic).

After the rinsing step, the multi-zone shower head can move to the top of the wafer for drying the wafer. The distance between the bottom of the shower head to the top of the wafer can be optimized for process performance, being between 0.25 to 2 inch, with 0.75 inch preferred. The process can use the backside nozzles for drying wafer, with the nozzles being attached to the arm of a motor. The movement can be radial or linear motion to dry a substrate from center to edge. The rinsing and drying system can comprise a shroud covering the wafer, in which the shroud moves up during process steps to avoid water splashing to outside and moving down during loading and un-loading wafer. The design configuration allows the wafer to pass between wet and dry robots.

The rinsing and drying process can proceed with the rinse liquid agent flooding and covering the entire wafer surface before the drying process. The process can use the edge nozzles with programmable flow rate to control the radial liquid boundary condition. The process can stop or adjust the DIW flow at controlled flow rate to design the end step where the liquid boundary, is about 1.5 inch from wafer edge, depending on the surface tension of wafer and wafer edge. The process can combine the shower head zones flow rate, the spinning rotation speed, the edge nozzles DIW flow and the duration to control the drying process. The flow rate is approximate from 50 to 500 cc/min, and preferably 250 cc/min. The process can maintain and control the circular boundary of the rinse DIW. This boundary is expanding due to combination of the force from the carrier air, the change in surface tension and the centrifugal force.

The process can proceed where all air zones need to maintain a laminate flow. The process can proceed where N₂/IPA starts from the center zone then moves gradually to the edge zone. The N₂/IPA can be dispensed through multiple circular zones radially distributed from the wafers center. The N₂/IPA flow can be stopped after each zone achieving a drying boundary condition. The N₂/IPA flow can also continue after each zone already achieving drying boundary condition for extra drying or deep trench drying. At the end of the process, the drying agent can being dispensed through all zones continuously.

The process can proceed where the pressure or flow rate can increase at each zone to increase the force to push the DIW water to the edge direction. The process can open air zone after circular DIW boundary passed the air zone. The process can use the last 1 or 2 air zones in the shower head for drying the wafer edge. The process can perform where there is no air exposure to the surface of wafer during the drying process. Only N₂ and IPA vapor are present between the drying head and wafer surface.

The process can comprise two outer zones to target wafer edge drying, with front and back nozzles located at approximation edge location to repel and dry wafer edge. The pressure and incident angle of the front side nozzle is larger than that of the backside nozzle. The process can comprise combining wafer rotation, front side and backside nozzles to dry a wafer edge. The process can comprise a final dry step using drying agent or nitrogen, with heated drying or heated nitrogen optional. The process can comprise a showerhead acting as a physical shield to prevent liquid splash back. The process can comprise low wafer spinning speed from 5 to 200 rpm for complete drying process, with max 150 rpm preferred. The process can comprise DIW nozzles flowing from the edge of wafer to control boundary condition of liquid on wafer.

The process can comprise process parameter to achieve a disruptive flow on the surface of the wafer of the water meniscus. The process can comprise a controlled surface tension of water meniscus over the entire surface of the wafer with low rpm and with gradually increasing rotation speed to remove rinse liquid from wafer edge. The process can comprise the use of nitrogen as carrier gas. The process can comprise the controlled displacement of water with N₂ gas. The process can comprise the IPA/DIW azeotrope vaporization of remaining water on surface. The process can comprise the drying agent or azeotrope agent of Isopropyl Alcohol, Ethyl glycol, Diacetone or Methylpyrrolidone. The process can comprise a carrier gas of nitrogen, argon, helium or krypton. The process can comprise low IPA consumption of less than 3 cc per wafer, where the carrier gas and IPA vapor is at room temperature.

The cleaning process can provides uniform flow with the showerhead uniformly dispense chemicals on the wafer. The cleaning process can be repeated by allowing different type of cleaning agent can be dispended on same zone for additional cleaning after each zone complete. The cleaning process can be performed from both sides in which the back side of wafer can be cleaned from nozzle with same or different cleaning agent from the front side. The backside nozzles can be rotated from wafer center to edge or moved linearly from center to edge. The cleaning process can be performed where the cleaning agent flow and travel speed of the nozzles backside can be controlled to match wafer spinning. The cleaning agent could be a RCA-based chemical, HF, H₂SO₄, HNO₃, HCl, H₂O₂, H₂CO₃, or any combination thereof. The cleaning agent could also be a liquid, a saturated vapor, vapor phase, or a mixture with inert gas.

The following is another embodiment of a wet process according to the present invention. This process dispenses a uniform layer of vapor on the wafer surface for rinsing and drying a wafer.

1. Preparing the process.

2. Rotating the wafer. The spinning is preferably gradual, starting slowly and the increasing speed gradually. This step is optional, and preferably employed for uniform processing.

3. Dispensing a flow of a drying agent from the center zone or from a vicinity of the center zone onto the front side of the wafer. The wafer is preferably spinning at controlled speed and duration during the dispensing step for uniform distribution. Further, the centrifugal force resulting from the rotation pushes and urges any liquid on the wafer to move and flow out to the edge of wafer. The rotation is preferably running from slow to fast, and controlled by the recipe matrix parameter. The drying agent can comprise a carrier gas (such as non-reactive gas or inert gas), a liquid, a saturated vapor, a vapor, or any combination thereof. The wafer can be rinsed with water or DIW before drying.

The drying flow is preferably dispensed circumferentially in a ring pattern. The cleaning flow can also be dispensed linearly in a line pattern. The drying flow and pressure is preferably controlled to match the rotation speed of the wafer.

4. Flowing a liquid onto the vicinity of the edge of the wafer to maintain the liquid layer on the top substrate surface. The edge flow is preferably designed to maintain a steady state liquid boundary condition for the substrate. The wafer spinning will push the liquid out of the wafer, thus the edge flow is needed to establish a boundary condition, or to generating a steady state layer of liquid on the wafer surface. With the wafer spinning, only one or two edge nozzles are adequate for supplying the edge flow to all the circumference of the wafer. If the wafer is not rotated, then more nozzles might be needed for uniformly distributed the edge flow. Also rotating edge flow might help in the uniform distribution. The edge liquid is preferably water or DIW, or any cleaning or rinsing liquid.

Before the edge flow, the process can provide a layer of cleaning or rinsing liquid on the top surface of the wafer. The liquid can be water, DIW, a cleaning agent, or any chemical agent for rinsing the wafer top surface. The wafer is then rotated to spread out the liquid on the wafer surface.

5. Propagating the flow of the drying agent outward toward the edge of the substrate. The propagating process can comprise the dispensing subsequent flows of the drying agent closer to the edge of the substrate than the previous flows. The propagating process is preferably performed by the continuing dispensing a flow of drying agent at subsequent outer zones. During the subsequent flows, the previous flows can be stopped or can still be flowing. The flow rate or the pressure of the previous flows is preferably higher than those of the subsequent flow to move the drying agent toward the edge of the substrate. The flowing rate or the pressure of the flows is preferably gradually increased with time for better process control. The propagation starts at the center zone, then moves to outer zones, and finally stops at the edge zone to drying the entire wafer. The propagating flow is preferably dispensed circumferentially in a ring pattern, or can also be dispensed linearly in a line pattern. The flow propagation speed is preferably controlled to match the substrate rotational speed.

The drying process can also comprise a step of uniformly dispensing drying agent on the wafer. After each zone is dry, depending on the process requirements, different type of drying agent can also be dispended for additional drying step. Thus the flow propagation from the center to the edge of the substrate is repeated with the same drying agent or with different drying agent.

The drying agent preferably has a lower surface tension than the liquid agent so that the surface tension difference between the two agents provides a force to push liquid outward toward the edge. For DIW as a liquid agent, the drying agent is preferably isopropyl alcohol, ethyl glycol, diacetone or methylpyrrolidone, and preferably in vapor phase for faster and better drying process. The drying agent preferably comprises a carrier gas, with a small fraction of low surface tension vapor. The drying flows preferably provide a laminar flow for uniform drying without water streak marks. The propagation of the drying flows creates a disruptive flow on the surface of the substrate of the liquid meniscus, which pushes the liquid layer steadily toward the wafer edge. Also, the drying agent and the liquid agent preferably form an azeotrope solution to ensure consistency of the liquid layer in drying by vaporization process. The azeotrope solution can be DIW with isopropyl alcohol, ethyl glycol, diacetone or methylpyrrolidone.

5. The edge liquid flow stops when the drying front propagates reaches a certain predetermined distance from the wafer edge. This distance is typically less than 3 inches, and preferably about 1 to 1.5 inches from the wafer edge. This distance is optimizable from the drying propagation front and the edge liquid boundary condition to maintain a layer of liquid where the drying flows have not reached.

6. The backside of wafer can also be drying from nozzle with the same or different cleaning agent in the same time. The backside nozzles can be rotated from wafer center to edge or moved linearly from center to edge. The drying agent flow and the travel speed of the nozzles backside can be controlled to match wafer spinning.

6. After the wafer top surface is dry, the wafer side edge can be clean. The wafer edge drying process uses a front and a back edge drying nozzles at proper location facing the wafer edge. Generally speaking, the pressure, flow rate and the incident angle of the front drying nozzle are higher than those of the back drying nozzle to ensure the repelling and the drying of the wafer edge without contaminate the front side of the wafer.

What the claimed is:

1. A method for wet processing a substrate, comprising the step of
b) flowing a liquid onto a vicinity of an edge of the substrate to maintain a liquid layer on the top substrate surface.

2. A method as in claim 1 further comprising a step before step b)
a) providing a layer of liquid on the top substrate surface.

3. A method as in claim 1 further comprising a step after step b)
c) providing a flow of a chemical agent onto the substrate;
d) propagating the flow outward toward the edge of the substrate.

4. A method as in claim 1 further comprising a step of rotating the substrate.

5. A method for wet processing a substrate, comprising the step of
a) dispensing a first flow of a liquid agent onto the substrate;
b) propagating the liquid agent flow outward toward the edge of the substrate.

6. A method as in claim 5 wherein the wet process is a cleaning process and the liquid agent is a cleaning agent.

7. A method as in claim 5 wherein the propagating step comprises the dispensing the flow of the liquid agent closer to the edge of the substrate.

8. A method as in claim 5 further comprising a step of continuing the propagating a flow of the liquid agent until reaching the edge of the substrate.

9. A method as in claim 5 further comprising a step of rotating the substrate for moving the cleaning agent toward the edge of the substrate.

10. A method as in claim 5 further comprising a backside nozzle to process the backside of the substrate simultaneously.

11. A method as in claim 5 wherein the flow propagation from the center to the edge of the substrate is repeated with the same liquid agent or with different liquid agent for additional processing.

12. A method for drying a substrate, comprising the step of
a) dispensing a first flow of a drying agent onto the substrate;
b) dispensing an edge flow of a liquid agent onto a vicinity of an edge of the substrate;
c) propagating the drying agent flow outward toward the edge of the substrate.

13. A method as in claim 12 further comprising a side edge drying step after drying the whole substrate top surface.

14. A method as in claim 12 wherein the drying agent has a lower surface tension than the liquid agent wherein the surface tension difference provides a force to push liquid outward.

15. A method as in claim 12 further comprising a step of flooding the substrate with a rinse liquid agent before dispensing the drying flow.

16. A method as in claim 12 wherein the edge flow maintains a steady state liquid boundary condition for the substrate.

17. A method as in claim 12 wherein the drying agent and the liquid agent forms an azeotrope solution.

18. A method as in claim 12 wherein the drying agent comprises a carrier gas, a liquid, a saturated vapor, a vapor, or any combination thereof.

19. A method as in claim 12 further comprising a step of rotating the substrate.

20. A method as in claim 12 further comprising a backside nozzle to process the backside of the substrate simultaneously.
